(19) United States
(12) Patent Application Publication
(10) Pub. No.: US 2026/0148221 A1
(43) Pub. Date: May 28, 2026

(54) ECOMMERCE POINT-OF-SALE TRANSACTION FOR OFFLINE TRANSACTIONS

(71) Applicant: Mastercard International Incorporated, Purchase, NY (US)

(72) Inventors: David Vorhies, Saint Charles, MO (US); Shawn Mehrhoff, Sappington, MO (US); Christopher T. Scholl, Manchester, MO (US)

(73) Assignee: Mastercard International Incorporated, Purchase, NY (US)

(21) Appl. No.: 18/959,761

(22) Filed: Nov. 26, 2024

(51) Int. Cl. G06Q 20/32; G06Q 20/20

(52) U.S. Cl. CPC G06Q 20/322; G06Q 20/207

(57) ABSTRACT

Systems and methods for bypassing communication network disruptions in point-of-sale terminal-initiated financial transactions that include receiving, at a consumer mobile device, transaction data for a payment transaction from a merchant point-of-sale terminal, the transaction data identifying a product for purchase and an amount; transmitting the transaction data from the consumer mobile device to a merchant server; receiving, from the merchant server and at the consumer mobile device, a prompt to complete a transaction corresponding to the transaction data; receiving acceptance input from the consumer at the consumer mobile device; and based on the acceptance input, transmitting an acceptance to complete the transaction.

### FIELD OF THE DISCLOSURE

The field of the disclosure relates generally to electronic commerce and, more particularly, to bypassing communication network disruptions in point-of-sale terminal-initiated financial transactions.

### BACKGROUND

Typically, consumers may initiate transactions with point-of-sale terminals (e.g., retailer terminals) using a credit card, a mobile wallet application or other payment instrument. For instance, a consumer may initiate a transaction using Tap to Pay or Quick Response (QR) code payment methods, in each case relying on a payment application on the consumer's device to exchange information and complete the transaction with the point-of-sale terminal. Namely, the point-of-sale terminal combines consumer financial account information received from the payment application with transaction details and transmits a corresponding authorization request for the transaction—for example, via acquirer and interchange network—to the issuer of the consumer's financial account. Approval of the request travels along the same route, in a reverse direction, back to the point-of-sale terminal of the merchant.

However, disruptions of such communication routes can derail point-of-sale terminal-initiated transactions. Merchants experiencing disruptions (e.g., communication network disruptions) may be left with few good options. For example, they may be forced to decide whether to refuse transactions until normal communications are restored or to attempt offline transactions which leave the merchants open to greater risk of fraud, non-payment and the like.

Improved technological processes are needed to help merchants navigate communication capability disruptions.

### BRIEF DESCRIPTION

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one or more aspects, non-transitory computer-readable storage media having computer-executable instructions stored thereon for bypassing communication network disruptions in point-of-sale terminal-initiated financial transactions are provided. When executed by at least one processor the computer-executable instructions cause the at least one processor to: receive, at a consumer mobile device, transaction data for a payment transaction from a merchant point-of-sale terminal, the transaction data identifying a product for purchase and an amount; transmit the transaction data from the consumer mobile device to a merchant server; receive, from the merchant server and at the consumer mobile device, a prompt to complete a transaction corresponding to the transaction data; receive acceptance input from the consumer at the consumer mobile device; and based on the acceptance input, transmit an acceptance to complete the transaction.

Further, in one or more aspects, non-transitory computer-readable storage media having computer-executable instructions stored thereon for bypassing communication network disruptions in point-of-sale terminal-initiated financial transactions are provided. When executed by at least one processor the computer-executable instructions cause the at least one processor to: transmit, from a merchant point-of-sale terminal, transaction data for a payment transaction to a consumer mobile device, the transaction data identifying a product for purchase and an amount; receive, from the consumer mobile device, the transaction data at a merchant server; determine, at the merchant server, that the transaction data corresponds to a transaction initiated at a merchant location; based on the determination, automatically prepare, at the merchant server, a prompt to complete a transaction corresponding to the transaction data; transmit the prompt to the consumer mobile device; and receive, at the merchant point-of-sale terminal and from the consumer mobile device, a transmission indicating acceptance by the consumer of the transaction.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of other and different aspects, and their details are capable of modification in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a schematic diagram illustrating an exemplary multi-party payment network system for processing payment card transactions;

FIG. 2 is a schematic diagram illustrating an exemplary cardholder computing device for the system shown in FIG. 1;

FIG. 3 is a schematic diagram illustrating an exemplary computing system comprising a point-of-sale merchant terminal of the system shown in FIG. 1;

FIG. 4 is a schematic diagram illustrating an exemplary server system operated by any of various entities in the system shown in FIG. 1; and

FIG. 5 is a flowchart illustrating an exemplary computer-implemented method for bypassing communication network disruptions in point-of-sale terminal-initiated financial transactions, in accordance with an embodiment of the present disclosure.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. The scope of the present invention is defined only by the appended claims, along with the full scope of equivalents to which such claims are entitled.

The methods and systems described herein may be implemented using computer programming or engineering techniques including computer software, firmware, hardware, or any combination or subset therefor. At least one of the technical problems addressed by this system includes enabling a merchant to reduce the risk of fraudulent or unsuccessful transactions while continuing to make point-of-sale terminal-initiated financial transactions during communication interruptions.

A reconfigured merchant point-of-sale terminal and merchant server may cooperate with a complementarily-configured cardholder payment application under embodiments of the present invention to provide a technical solution to the problem. More particularly, the reconfigured merchant point-of-sale terminal and merchant server complete a new transaction type responsive to network or communication interruptions—referred to herein as an ecommerce point-of-sale transaction (ECOM POS). The ECOM POS transaction type may bypass the interrupted or disrupted communication lines typically implemented for merchant point-of-sale terminal-initiated financial transactions while avoiding many of the risks inherent in offline transactions.

As will be appreciated, based upon the description herein, the technical improvement in enabling a merchant and cardholder to transact in this manner is a computer-based solution to a technical deficiency or problem that is itself rooted in computer technology (i.e., the problem itself derives from the use of computer technology). The present disclosure improves upon the conventional methods and systems in the manners described herein.

### Example System

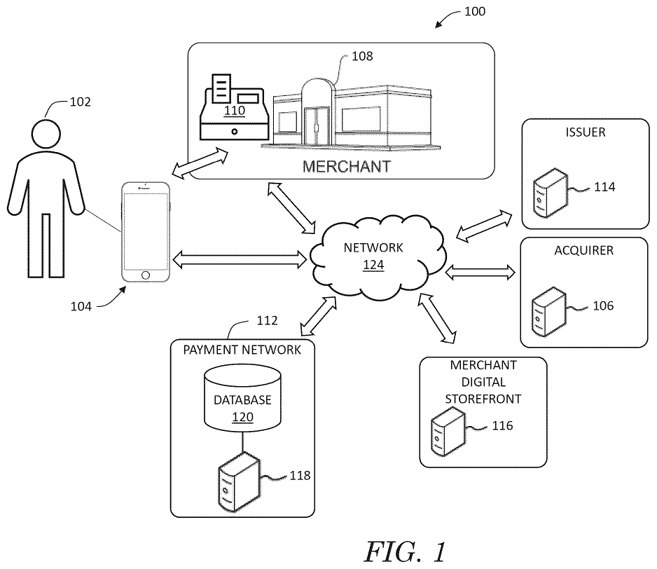

FIG. 1 is a schematic diagram illustrating an exemplary multi-party payment processing system 100 for processing payment transactions, in accordance with aspects of the present invention. In the example payment processing system 100, a cardholder 102 may have access to a consumer computing device 104 through which the cardholder 102 may perform a payment transaction to a merchant 108.

Embodiments described herein may relate to a payment card system, such as a payment system using the Mastercard® interchange network. (Mastercard is a registered trademark of Mastercard International Incorporated.). The Mastercard interchange network is a set of proprietary communications standards promulgated by Mastercard for the exchange of financial transaction data and the settlement of funds between financial institutions that are members of the Mastercard interchange network. Embodiments described herein may also relate to digital payment services such as those offered under the CLICK TO PAY™ mark by Mastercard or another digital wallet service for a mobile device such as a smartphone.

In the example embodiment, the payment card network system 100 generally includes the acquirer 106, merchant 108, the interchange or payment network 112, the issuer 114, and the merchant's digital storefront 116, coupled in communication via a communications network 124.

As used herein, financial transaction data includes a unique account number associated with an account holder using a payment card issued by an issuer, purchase data representing a purchase made by the cardholder, including a type of merchant, amount of purchase, date of purchase, and other data, which may be transmitted between any parties of multi-party payment card network system 100.

In payment processing system 100, a financial institution, such as an issuing bank or issuer 114 (and its associated computers), issues a payment account, such as a credit card account or a debit card account, to the cardholder 102, who uses the payment account (or payment card associated with the payment account) to tender payment for a purchase from the merchant 108. To accept payment from the cardholder 102, the merchant 108 must normally establish an account with a financial institution that is part of the system 100. This financial institution is usually called a “merchant bank,” an “acquiring bank,” or simply an “acquirer,” represented by reference character 106.

When the cardholder 102 tenders payment for a purchase (e.g., with a payment card, virtual card, digital wallet, etc.), the merchant 108 requests authorization from the acquirer 106 (and its associated computers) for the amount of the purchase. The request may be performed through the use of a point-of-sale (POS) terminal of the merchant 108, such as the POS terminal 110. The POS terminal 110 reads the cardholder's account information from the payment card or digital wallet and communicates electronically with the transaction processing computers of the acquirer 106. Alternatively, the acquirer 106 may authorize a third party to perform transaction processing on its behalf. In such a case, the POS terminal 110 may be configured to communicate with the third party. Such a third party is usually called a “merchant processor” or an “acquiring processor.”

Using a payment network 112 (or payment processor), computers of the acquirer 106 or the merchant processor will communicate with computers of the issuing bank or issuer 114 to determine whether the cardholder′ s account is in good standing and whether the purchase amount is covered by the cardholder's available credit line or account balance. Based on these determinations, the request for authorization will be declined or accepted. If the request is accepted, the transaction is given a bank network reference number, such as the Banknet Reference Number, an authorization code, and/or other transaction identifiers that may be used to identify the transaction.

In contrast, when purchasing a product over the Internet, a payment card number (e.g., credit cards and debit cards) is generally submitted to a merchant e-commerce website or merchant digital storefront 116. The storefront 116 prepares and transmits an electronic communication to the payment card issuer 114 for authorization of a total purchase price, and an electronic debiting of the customer's 102 account when the authorization is successful.

Payment network 112 facilitates the exchange of financial transaction data between financial institutions that are members/customers of the payment interchange networks for processing payment card based transactions. Examples of the members include the issuer banks 114, the acquirer banks 106, wallet application providers and the like. A payment service provider (PSP) or a payment gateway (another example of a member of the payment network 112) offers online services to merchants for accepting electronic payments by a variety of payment methods including credit card, bank-based payments such as bank transfer, and online banking.

A normal transaction flow for a successfully completed e-commerce transaction involves user 102 selecting the product for purchase from a merchant portal of merchant digital storefront 116, being redirected to the payment gateway of the payment network 112 for providing card details of the transaction data, and forwarding of the card details to the issuer 114 via the acquirer 106 for authorization and subsequent steps as described in more detail above. Further, if the issuer 114 authorizes the transaction successfully, electronic debiting of the user account is processed. Thereafter, a response of an approved transaction is sent back to the merchant 108 via the acquirer 106 and the payment gateway so that the merchant 108 can dispatch product purchased by the user 102. Sending response of an approved transaction to the merchant 108 is the last leg of the transaction where the transaction is processed by respective entities of the payment network 112 successfully.

The consumer computing device 104, the POS terminal 110 (except in periods of disruption), the acquirer computers 106, the payment network 112, the merchant digital storefront 116, and the issuer computers 114 may be coupled in communication via a communications network 124. The network 124 may include, for example and without limitation, one or more of a local area network (LAN), a wide area network (WAN) (e.g., the Internet, etc.), a mobile network, a virtual network, and/or any other suitable public and/or private network capable of facilitating communication among the components of system 100. In some embodiments, the network 124 may include more than one type of network, such as a private payment transaction network provided by the payment network 112 to the acquirer computers 106 and the issuer computers 114, and, separately, the public Internet, which may facilitate communication between the POS terminal 110 (or merchant 108), the payment network 112, the acquirer computers 106, the issuer computers 114, the merchant digital storefront 116, and the cardholder computing device 104, etc.

The payment processing system 100 may be configured to process authorization messages, such as ISO® 8583 compliant messages and ISO® 20022 compliant messages. (ISO is a registered trademark of the International Organization for Standardization of Geneva, Switzerland.) As used herein, ISO refers to a series of standards approved by the International Organization for Standardization. ISO 8583 compliant messages are defined by the ISO 8583 standard, which governs financial transaction card-originated messages and further defines acceptable message types, data elements, and code values associated with such financial transaction card originated messages. ISO 8583 compliant messages include a plurality of specified locations for data elements. ISO 20022 compliant messages are defined by the ISO 20022 standard. ISO 20022 compliant messages may include acquirer to issuer card messages (ATICA).

During an authorization process of the payment processing system 100, a clearing process is also taking place. During the clearing process, the acquirer 106 provides issuing bank 114 with information relating to the purchase. No money is exchanged during clearing. Clearing (also referred to as “first presentment”) involves the exchange of data (e.g., financial transaction data) required to identify the cardholder's account, such as the account number, expiration date, billing address, amount of the sale, and/or other transaction identifiers that may be used to identify the transaction. Along with this data, banks in the United States also include a bank network reference number, such as the Banknet Reference Number, which identifies that specific transaction. When the issuing bank 114 receives this data, it posts the amount of sale as a draw against the available credit in the cardholder account and prepares to send payment to the acquirer 106.

After a request for authorization is accepted, the available credit line or available account balance of cardholder's account is decreased. Normally, a charge is not posted immediately to a cardholder's account because bankcard associations, such as Mastercard, have promulgated rules that do not allow a merchant to charge, or “capture,” a transaction until the purchased goods are shipped or services are delivered. When the merchant 108 ships or delivers the goods or services, the merchant 108 captures the transaction by, for example, appropriate data entry procedures on the POS terminal 110. If the cardholder 102 cancels a transaction before it is captured, a “void” is generated. If the cardholder 102 returns goods after the transaction has been captured, a “credit” is generated. The payment network 112 may store the transaction information, such as, and without limitation, a type of merchant, a merchant identifier, a location where the transaction was completed, an amount of purchase, and a date and time of the transaction, in a transaction database, such as the transaction database 120.

After a transaction is authorized and cleared, the transaction is settled between the merchant 108, the acquirer 106, and the issuing bank 114. Settlement refers to the transfer of financial data or funds between the merchant's 108 account, the acquirer 106, and issuing bank 114 related to the transaction. Usually, transactions are captured and accumulated into a “batch,” which is settled as a group.

### Exemplary Computer Systems

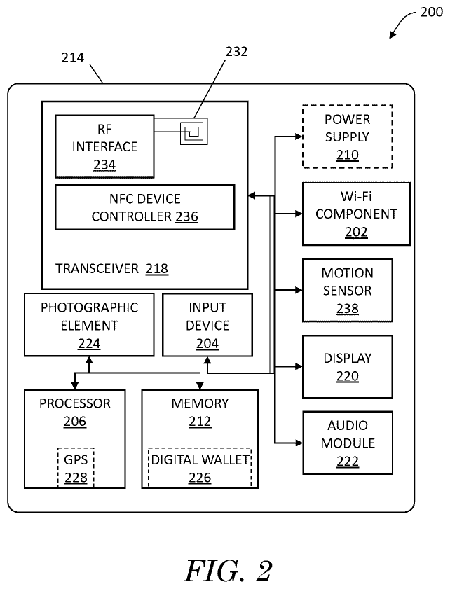

FIG. 2 is an example configuration of a user computing system 200, such as the consumer computing device 104 that may be operated by a user, such as the cardholder 102 (shown in FIG. 1). In the exemplary embodiment, the computing system 200 may be a computing device configured to connect wirelessly to one or more of the merchant 108, the POS terminal 110, the network 124, the merchant digital storefront 116 and any other computing devices associated with the system 100.

In the exemplary embodiment, the computing system 200 may generally include a processor 206, a memory device 212, a transceiver 218 (or a wireless communication device), and a photographic element 224. In addition, the computing system 200 may include an integrated Wi-Fi component 202 (e.g., implementing the Institute of Electrical and Electronics/IEEE 802.11 family of standards), an input device 204, a display 220, and an audio module 222. Moreover, the computing system 200 optionally may include an internal power supply 210 (e.g., a battery or other self-contained power source) to receive power. Optionally, the computing system 200 may include a motion sensor 238.

The processor 206 may include digital processing unit(s) and/or one or more processing units (e.g., in a multi-core configuration) specially programmed for executing computer readable instructions. The instructions may be executed within a variety of different operating systems (OS) on the computing system 200, such as UNIX, LINUX, Microsoft Windows®, etc. More specifically, the instructions may cause various data manipulations on data stored in the memory device 212 (e.g., create, read, write, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.). The memory device 212 may be any device allowing information such as payment card data, the executable instructions, and/or other data to be stored and retrieved. The memory device 212 may include one or more computer readable media.

A location of the computing system 200 may be obtained through conventional methods, such as a location service (e.g., global positioning system (GPS) service) in the computing system 200, “ping” data that includes geotemporal data, from cell location register information held by a telecommunications provider to which the computing system 200 may be connected, and the like. For example, in one suitable embodiment, a GPS chip 228 may be part of or separate from the processor 206 to enable the location (or geolocation) of the computing system 200 to be determined.

The Wi-Fi component 202 (broadly, a communication interface) may be communicatively connectable to a remote device such as the merchant computer or POS terminal 110 and the network 124. The Wi-Fi component 202 may include, for example, a wireless or wired network adapter or a wireless data transceiver for use with Wi-Fi (e.g., implementing the Institute of Electrical and Electronics/IEEE 802.11 family of standards), Bluetooth communication, radio frequency (RF) communication, near-field communication (NFC), and/or with a mobile phone network, Global System for Mobile communications (GSM), 5G, or other mobile data network, and/or Worldwide Interoperability for Microwave Access (WiMax) and the like.

Stored in the memory device 212 may be, for example, computer readable instructions for providing a user interface to the user, such as the cardholder 102, via the display 220 and, optionally, receiving and processing input from the input device 204. A user interface may include, among other possibilities, a web browser, a client application, a digital wallet application 226, and the like. Web browsers may enable users, such as the cardholder 102, to view and interact with media and other information typically embedded on a web page or a website such as a merchant portal of the merchant digital storefront 116. A digital wallet may allow the cardholder 102 to receive, generate, and/or store payment credentials, such as tokens associated with a payment card and/or a virtual payment credential. The digital wallet application 226 (broadly, a digital wallet), is linked to a digital wallet service and/or installed on the user computing system 200. It is contemplated that more than one digital wallet may be associated with the user computing system 200 and accessible by the user interface, where each digital wallet is associated with at least one financial institution (such as the issuer 114).

The photographic element 224 may include a camera or other optical sensor and lens combination capable of generating a video signal and capturing an image, iris scan, and the like. In various embodiments, the photographic element 224 may be integrated in a housing or body, such as a housing 214, of the computing system 200. When the photographic element 224 captures an image or otherwise generates image data (e.g., video data), the photographic element 224 may store the image data in a data file, either in a raw or compressed format, in the memory device 212. In various embodiments, the photographic element 224 may, including at the direction of the digital wallet 226, capture transaction data displayed as a QR code by the terminal 110.

In some embodiments, the motion sensor 238 may include one or more sensor elements that facilitate detecting a person's presence. For example, the motion sensor 238 may detect when the cardholder 102 moves or raises the user consumer system 200. Upon detection of such motion, the photographic element 224 may begin capturing images (e.g., still or video images), the transceiver 218 may be activated, and/or the audio module 222 may begin capturing audio. The motion sensor 238 may be operatively coupled to the photographic element 224 such that the consumer's presence may be detected by detecting motion using the photographic element 224. The motion sensor 238 may include, for example, and without limitation, sensor elements such as a passive infrared sensor, an ambient light sensor, and the like.

In the example embodiment, the display 220 may include, for example, and without limitation, a liquid crystal display (LCD), an organic light emitting diode (OLED) display, or an “electronic ink” display. In some embodiments, a single component such as a touch screen may function as both an output device (e.g., the display 220) and the input device 204. As such, the display 220 may optionally include a touch controller for support of touch capability. In such embodiments, the computing system 200 may detect the presence of the cardholder 102, for example, by detecting that the cardholder 102 has touched the display 220 of the computing system 200. In various embodiments, the display 220 may, including at the direction of the digital wallet 226, display transaction data and/or confirmation of completed transaction signals as a QR code for capture by an optical sensor or photographic element of or in communication with the terminal 110.

The audio module 222 may include, for example, and without limitation, a speaker and related components capable of broadcasting streaming and/or recorded audio and may also include a microphone. The microphone facilitates capturing audio through the computing system 200.

In one or more embodiments, the transceiver 218 may include an antenna 232. The antenna 232 includes a looped wire configured to transmit radio signals when current flows through the looped wire. The antenna 232 is any size, shape, and configuration that is suitable for transmitting signals as described herein. For example, the antenna 232 may be a tuned circuit configured to transmit radio signals in any radio-based communication system including, but not limited to, Radio Frequency Identification (RFID), Wireless Local Area Network (WLAN), and Wireless Personal Area Network (WPAN) systems. In the example embodiment, the antenna 232 generates a magnetic field when it vibrates at a selected frequency. Specifically, the antenna 232 may be configured to vibrate at a frequency of about 13.56 MHz, which is suitable for use in a near field communication (NFC) system.

In the example embodiment, the antenna 232 may transmit radio signals to and may receive radio signals from other wireless-enabled computing devices, for example, another mobile device, the computers, devices, or systems 106, 110, 112, 114, and 116, and/or any other components used in wireless systems. In NFC systems, for example, at least one NFC component generates a magnetic field to inductively transfer currents and, thereby, exchange signals and information with other NFC components positioned within the magnetic field. In one example embodiment, the antenna 232 may function as an NFC component to send and receive signals. The antenna 232 may be configured to transmit radio signals to NFC components positioned within the magnetic field of the antenna 232, such as when the computing system 200 is positioned within a predetermined distance of the merchant computer or POS terminal 110. Therefore, the magnetic field generated by the antenna 232 may define the active range of the computing system 200. Additionally, the antenna 232 may receive radio signals from NFC components when the antenna 232 is positioned within the magnetic field of the NFC components.

The transceiver 218 also may include a radio frequency (RF) interface 234 and an NFC device controller 236. The RF interface 234 and the NFC device controller 236 may be powered by the internal power supply 210 and/or the display 220. In addition, the processor 206 and the memory device 212 may be powered in the same manner. The RF interface 234 may be configured to receive and transmit RF signals through the antenna 232. The NFC device controller 236 may be configured to process the received RF signals and to generate signals to be transmitted by the RF interface 234. The memory device 212 may be configured to store data associated with transmitting and receiving the RF signals. The NFC device controller 236 may be coupled in communication with the processor 206.

In some embodiments, the computing system 200 may be connected to one or more peripheral devices (not shown). That is, the computing system 200 may communicate various data with one or more peripheral devices. For example, the computing system 200 may communicate with one or more peripheral devices through the Wi-Fi component 202, the transceiver 218, or other suitable means.

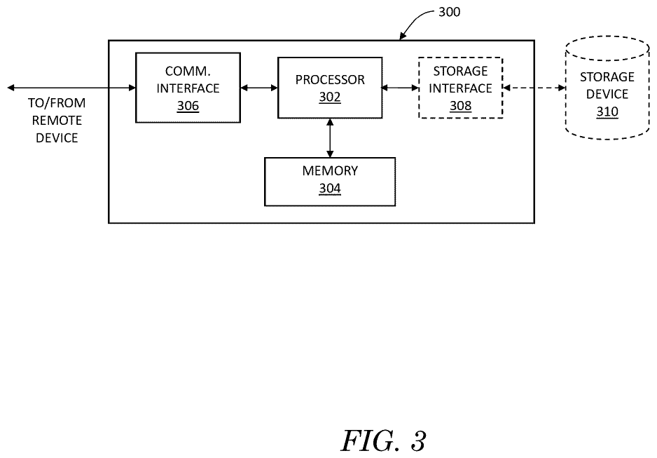

FIG. 3 is an example configuration of a computing system 300. In an embodiment, the computing system 300 may include, but not be limited to, the merchant computer or POS terminal 110. In the example embodiment, the computing system 300 may include a processor 302 for executing instructions. The instructions may be stored in a memory 304, for example. The processor 302 may include one or more processing units (e.g., in a multi-core configuration) for executing the instructions. The instructions may be executed within a variety of different operating systems on the computing system 300, such as UNIX, LINUX, Microsoft Windows®, etc. More specifically, the instructions may cause various data manipulations on data stored in a storage device 310 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

The processor 302 may be operatively coupled to a communication interface 306 such that the computing system 300 can communicate with a remote device such as a user computing system 200 (shown in FIG. 2), one or more of the computers, devices, or systems 104, 106, 110, 112, 114, and 116, and/or another server system. For example, the communication interface 306 may receive communications from a consumer computing device 104 and input from a merchant associate.

The processor 302 may be operatively coupled to the storage device 310. The storage device 310 may be any computer-operated hardware suitable for storing and/or retrieving data. In some embodiments, the storage device 310 may be integrated in the computing system 300. In other embodiments, the storage device 310 may be external to the computing system 300. The storage device may be similar to the database 120 (shown in FIG. 1). For example, the computing system 300 may include one or more hard disk drives as the storage device 310. In other embodiments, the storage device 310 may be external to the computing system 300 and may be accessed by a plurality of server systems 300. For example, the storage device 310 may include multiple storage units such as hard disks or solid-state disks in a redundant array of inexpensive disks (RAID) configuration. The storage device 310 may include a storage area network (SAN) and/or a network attached storage (NAS) system.

In some embodiments, the processor 302 may be operatively coupled to the storage device 310 via a storage interface 308. The storage interface 308 may be any component capable of providing the processor 302 with access to the storage device 310. The storage interface 308 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 302 with access to the storage device 310.

The memory 304 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

In one or more embodiments, the system 300 comprises a merchant POS terminal reconfigured suitably to conduct the operations discussed in more detail below in connection with an ECOM POS transaction flow.

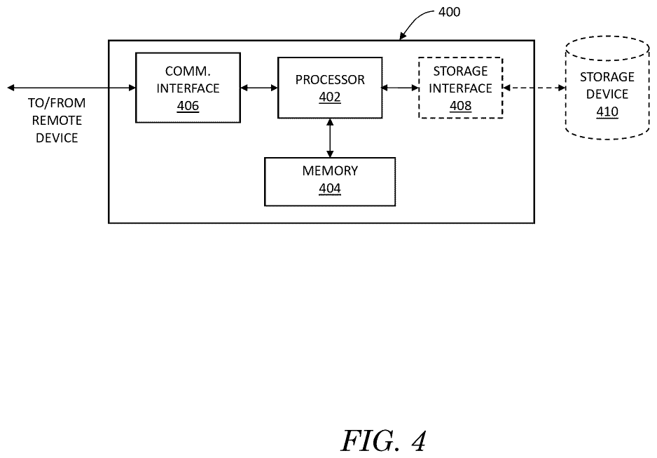

FIG. 4 is an example configuration of a server system 400, such as any of the server systems 112, 118, 116, 114 and/or 106 shown in FIG. 1. The server system 400 may comprise cloud servers, domain controllers, application servers, database servers, database web servers, file servers, mail servers, catalog servers or the like, or combinations thereof. The server system 400 may include, but is not limited to, a database server, e.g., where the system 400 is part of the payment network 112 and is coupled to, for example, one or more databases, such as the transaction database 120 (shown in FIG. 1).

In the example embodiment, the server system 400 includes a processor 402 for executing instructions. The instructions may be stored in a memory device 404, for example. The processor 402 includes one or more processing units (e.g., in a multi-core configuration) for executing the instructions, such as digital processing unit(s). The instructions may be executed within a variety of different operating systems on the server system 400, such as UNIX, LINUX, Microsoft Windows®, etc. It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

The processor 402 is operatively coupled to a communication interface 406 (e.g., a network interface) such that the server system 400 can communicate with a remote device such as a user computing device 200, merchant POS terminal 300 (shown in FIG. 3) or another server system 400. For example, the communication interface 406 may receive and transmit communications from the merchant POS terminal 110 and/or the consumer computing device 104 via the Internet, and/or may receive and transmit communications among any of the server systems 112, 118, 116, 114 and/or 106 shown in FIG. 1, as illustrated in FIGS. 1-3.

The processor 402 is operatively coupled to the storage device 410. The storage device 410 is any computer-operated hardware suitable for storing and/or retrieving data. In some embodiments, the storage device 410 is integrated in the server system 400. In other embodiments, the storage device 410 is external to the server system 400 and is similar to the storage devices of databases 24 and 40, as described above. For example, the server system 400 may include one or more hard disk drives as the storage device 410. In other embodiments, the storage device 410 is external to the server system 400 and may be accessed by a plurality of server systems 400. For example, the storage device 410 may include multiple storage units such as hard disks or solid-state disks in a redundant array of inexpensive disks (RAID) configuration. The storage device 410 may include a storage area network (SAN) and/or a network attached storage (NAS) system.

In some embodiments, the processor 402 is operatively coupled to the storage device 410 via a storage interface 408. The storage interface 408 is any component capable of providing the processor 402 with access to the storage device 410. The storage interface 408 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 402 with access to the storage device 410.

The memory device 404 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

In the example embodiment, the server system 400 is representative of the server system of the merchant digital storefront 116. The merchant digital storefront 116 is a transaction verification and processing system in communication with one or more of the issuer 114, the payment network 112 and the cardholder computing device 104 during a payment card transaction associated with a user, such as the cardholder 102.

### Exemplary Computer-Implemented Methods

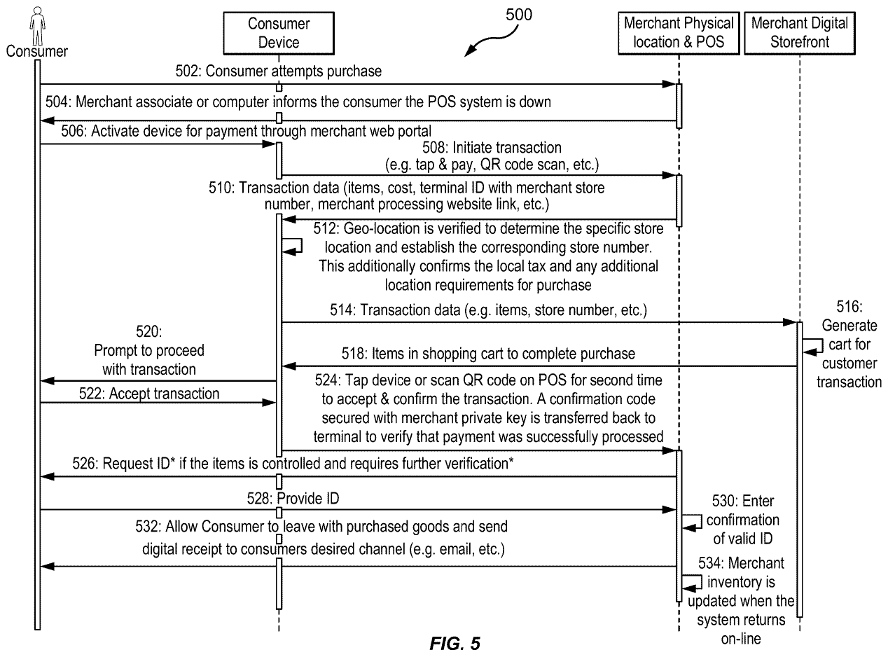

FIG. 5 is a flowchart illustrating an exemplary computer-implemented method 500 for bypassing communication network disruptions in point-of-sale terminal-initiated financial transactions, in accordance with one or more embodiments of the present disclosure. The operations described herein may be performed in the order shown in FIG. 5 or, according to certain inventive aspects, may be performed in a different order. Furthermore, some operations may be performed concurrently as opposed to sequentially, and/or some operations may be optional, unless expressly stated otherwise or as may be readily understood by one of ordinary skill in the art.

The computer-implemented method 500 is described below, for ease of reference, as being executed by exemplary devices and components introduced with the embodiments illustrated in FIGS. 1-4. In one or more embodiments, the computer-implemented method 500 is implemented by the consumer computing device 104/200, the merchant POS terminal 110/200, and the merchant digital storefront 116/400. While operations within the computer-implemented method 500 are described below regarding such systems and devices, according to some aspects of the present invention, the computer-implemented method 500 may be implemented using any other computing devices and/or systems through the utilization of processors, transceivers, hardware, software, firmware, or combinations thereof. A person having ordinary skill will also appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

Referring to operation 502, a consumer may attempt a purchase at a merchant physical location. In one or more embodiments, the attempt includes a card swipe or insertion, or other presentation of a physical payment card or device, to a merchant POS terminal (e.g., terminal 110/300). The payment device may be a consumer computing device (e.g., device 104/200), which may be brought into proximity to the merchant POS terminal to initiate NFC and/or QR code payment method communications. Also or alternatively, the consumer may inform a merchant employee or associate of a desire to make a purchase.

Referring to operation 504, the merchant may inform the consumer of a disruption in the ability of the merchant POS terminal to complete the putative purchase transaction. For example, in one or more embodiments, the merchant associate may verbally inform the consumer of the disruption. Also or alternatively, the merchant POS terminal or other merchant computing device may transmit a message to the consumer computing device and/or may display a message indicating the disruption.

The merchant POS terminal may be reconfigured for conducting an ECOM POS transaction via the consumer computing device when disruptions occur. The merchant POS terminal may be configured for conducting the ECOM POS transaction type at least in part by transmitting transaction data to the payment application of the consumer computing device for completion of the purchase transaction via payment request to a merchant digital storefront, by receiving confirmation of completion from the consumer computing device, and by performing corresponding record reconciliation, as described in more detail below.

The merchant POS terminal may be configured to automatically determine presence of the disruption, e.g., to identify a state of communication network disruption, and to correspondingly initiate the ECOM POS flow of method 500. For example, in one or more embodiments, the merchant POS terminal may monitor and/or detect errors in network communications.

The merchant POS terminal may be configured to periodically or continuously transmit test pings to one or more nodes along the communication pathway for normal merchant POS terminal transactions as discussed in more detail above (e.g., by transmitting pings to the acquirer and/or payment network), and to record the results of those pings for analysis (i.e., by recording whether the transmission was completed and/or a response was received). The merchant POS terminal may also be configured to receive data periodically or continuously gathered indicating network health and/or connectivity, which may similarly be analyzed.

In one or more embodiments, the merchant POS terminal may be configured to analyze such data and automatically determine a network disruption and, accordingly, to automatically implement the ECOM POS transaction flow described herein. The determination may include comparing the gathered connectivity and/or communication data to one or more thresholds or criteria which, if satisfied, automatically cause entry into the ECOM POS transaction flow mode or, if not satisfied, cause the merchant POS terminal to remain in normal merchant POS transaction flows.

Also or alternatively, the merchant POS terminal may be configured to detect or analyze records of previous transactions to determine presence of a network and/or communication disruption and, accordingly, automatically enter the ECOM POS transaction flow. For example, where a prior failed transaction has a connectivity and/or communication disruption error code, and/or where multiple prior failed transactions exhibit a pattern consistent with such a disruption, the merchant POS terminal may automatically initiate the ECOM POS transaction flow.

The merchant employee or associate may also or alternatively force the merchant POS terminal into the ECOM POS transaction flow through manual input or selection at an interface of the merchant terminal for receiving user input (e.g., touch display and/or push button switches of the terminal) and/or such input may be used to confirm entry into the ECOM POS flow as automatically suggested through the data analysis by the merchant POS terminal.

Referring to operation 506, the consumer may activate the consumer computing device for payment through a merchant web portal. In one or more embodiments, the activation includes selecting and running a payment application (e.g., a payment network and/or payment application of a digital wallet) configured for conducting an ECOM POS transaction via the consumer computing device. The payment application may be configured for conducting the ECOM POS transaction type at least in part via the new transaction flow according to which transaction data is received at the payment application from the merchant POS terminal and transmitted with a payment request to a merchant digital storefront, as described in more detail below. The payment application may automatically launch the ECOM POS flow (e.g., in response to a POS terminal transmission at operation 504) and prompt the consumer to activate the flow via confirmation at the consumer computing device, and/or the user may otherwise select and initiate the ECOM POS flow of the payment application at the consumer computing device.

Referring to operation 508, the transaction may be initiated by the consumer device communicating with the merchant POS terminal. In one or more embodiments, the consumer initiates a Tap to Pay or QR code scan transaction flow via the payment application of the consumer computing device, the flow being modified for the ECOM POS of embodiments of the present invention. Accordingly, the consumer computing device is brought into communication with the merchant POS terminal in one of these manners to begin the exchange of transaction data. In one or more embodiments, the payment application is, according to the modified ECOM POS flow, configured to request transaction data for the purchase from the merchant POS terminal.

Referring to operation 510, the merchant POS terminal transmits the transaction data to the payment application of the consumer computing device. In one or more embodiments, the transaction data identifies and/or describes the product(s) to be purchased, provides the cost or total amount to be paid, provides a merchant physical location identifier or terminal identifier, and provides any other information needed from the merchant to process a payment for the transaction. The transmission may be triggered at least in part or based on the existence of the disruption, for example where detection or identification of the disruption initially caused the merchant POS terminal to enter the ECOM POS flow. The transmission may also or alternatively be triggered in response to the request from the payment application of the consumer computing device for adherence to the ECOM POS flow.

The transaction data received from the merchant POS terminal may also include a processing website link or universal resource locator (URL) address for directing the consumer computing device to the corresponding merchant digital storefront. Also or alternatively, the consumer computing device and/or the payment application of the consumer computing device may store the URL for the merchant digital storefront, mapped to the merchant identifier directly or indirectly (e.g., via location determination at the consumer computing device and identification of the merchant physical location using geofencing techniques), for directing the consumer computing device to the corresponding merchant digital storefront (e.g., storefront 116).

It should also be noted that the merchant physical location identifier or terminal identifier may be alternatively determined or confirmed by the consumer computing device, in accordance with the description below, without departing from the spirit of the present invention.

Referring to operation 512, the location (e.g., geo-location) of the consumer computing device may be determined or confirmed by the consumer computing device. In one or more embodiments, the consumer computing device may rely on one or more of the following to determine the location of the consumer computing device and/or merchant location and/or terminal identifier(s): a location service accessible to the consumer mobile device; ping data that includes geotemporal data, from cell location register information held by a telecommunications provider to which the consumer mobile device is connected; and IP address register information. Where necessary, and depending on the use of the location information discussed in this paragraph (discussed in more detail below), the location information may be cross-referenced in one or more databases (e.g., including geo-fencing locators) to determine one or more of the merchant location and/or terminal identifier(s) as well as taxation information.

The location of the consumer computing device and/or merchant location and/or terminal identifier(s) may be used to confirm tax rate(s) applicable to the purchase (i.e., where based on the merchant physical location) and reconcile inventory records and sales attributions for that merchant physical location.

Referring to operation 514, the transaction data may be transmitted by the payment application of the consumer computing device to the merchant digital storefront. In one or more embodiments, the URL provided by the reconfigured merchant POS terminal and/or determined by the consumer computing device directs the consumer computing device to a webpage of the merchant digital storefront specially configured for the ECOM POS transactions. More particularly, the reconfigured webpage is reserved for use in ECOM POS transactions and automatically receives the transaction data from the consumer computing device (rather than, for example, receiving consumer selections of products generally made available at the merchant digital storefront).

The payment application of the consumer computing device may include primary account number (PAN) and/or encrypted or otherwise encoded representation of the payment account thereof, with the transaction data transmission to the merchant digital storefront, with any subsequent acceptance transmission to the merchant digital storefront, and/or with any corresponding transmission to third party payment processor or payment network provider supporting completion of the purchase transaction.

Referring to operation 516, the merchant digital storefront may generate a cart for the purchase transaction. In one or more embodiments, the merchant digital storefront automatically populates a shopping cart with the items for purchase and respective pricing received from or indicated by the transaction data from the consumer computing device, along with the appropriate taxes (e.g., based on the merchant physical location and/or identifier). The merchant digital storefront may also include a special identifier, label or flag for internal records and/or transmission to the payment network and/or issuer, indicating the putative purchase transaction is an ECOM POS transaction. The flag or label may also enable easier identification of the record for audits associated with chargeback and/or fraud review and/or confirmation (e.g., by a payment network) that consumer identification procedures were followed and satisfied.

The merchant digital storefront may be configured to determine that the transmission from the consumer computing device is for an ECOM POS transaction. For example, the webpage requested according to the URL employed by the consumer computing device to navigate to the merchant digital storefront may be dedicated to the ECOM POS transaction and related flow, making such a determination inherent. Also or alternatively, the payment application of the consumer computing device and/or the merchant POS terminal may generate a code or other label indicating the transaction is an ECOM POS transaction, and the transmission from the consumer computing device may include same. One of ordinary skill will appreciate that the merchant digital storefront may determine the classification of the transaction as being an ECOM POS transaction in a variety of ways without departing from the spirit of the present invention. The automatic preparation of the shopping cart and prompt to the consumer for acceptance of the transaction may be based at least in part on the determination that the transaction is an ECOM POS transaction.

Referring to operation 518, all or portions of the shopping cart, including description of the product(s), total amount of purchase and any attached purchase terms, may be transmitted by the merchant digital storefront to the consumer computing device for acceptance. In one or more embodiments, the payment application—which, in some cases, may include or direct a web browser to conduct the ECOM POS transaction with the merchant digital storefront—may receive the shopping cart transmission. The shopping cart transmission may include or comprise a prompt (e.g., instructions to the payment application for generating and/or displaying a prompt) to the consumer for completion of the transaction.

In one or more embodiments, a code or key is transmitted by the merchant digital storefront with the shopping cart transmission of operation 518 and/or subsequent transmission to the consumer computing device in connection with completion of the purchase transaction. The code or key may be encrypted or otherwise secured from decoding, knowledge and/or manipulation by the consumer. The code or key may be a merchant private key for encrypting or encoding information indicating completion of the purchase transaction. The merchant private key, or information encoded therewith, may only be decoded by other merchant devices, such as the merchant POS terminal, such that secure proof that the ECOM POS transaction was completed may be passed in real-time from the merchant digital storefront to the merchant POS terminal, despite the communication and/or connectivity disruptions occurring at the merchant POS terminal.

It should also be noted that payment account data of the transaction data may be submitted via the consumer computing device to a third party payment service provider in connection with completing the purchase transaction, in accordance with ecommerce transactions discussed in more detail above.

Referring to operation 520, the consumer computing device may prompt the consumer to accept the transaction. In one or more embodiments, the prompt is displayed on a display of the user computing device.

Referring to operation 522, the consumer may input, via input device or other component of the consumer computing device, acceptance of the purchase transaction. The payment application of the consumer computing device and/or web browser may transmit the acceptance to the merchant digital storefront or participating third party payment network provider to complete the transaction.

The merchant digital storefront may, in turn, submit a corresponding authorization request to the issuer, receive authorization therefrom (e.g., including a transaction identifier signifying the authorization), and convey the authorization to the consumer computing device to indicate completion of the transaction. The authorization process may otherwise proceed and be conducted via third parties (e.g., payment network, payment service provider and/or acquirer) as discussed in more detail above in connection with ecommerce transactions, provided that operations involving communication with the merchant POS terminal are unavailable. The transmission to the consumer computing device signaling completion of the transaction may include the transaction identifier and/or merchant private key for conveyance to the merchant POS terminal, as discussed in more detail below.

Referring to operation 524, the consumer may reestablish communication with the merchant POS terminal to confirm acceptance of the transaction. In one or more embodiments, the consumer activates the payment application to communicate wirelessly (e.g., via NFC and/or optical QR code display) with the merchant POS terminal and convey data indicating completion of the transaction. In one or more embodiments, the merchant private key and/or information securely encoded with the merchant private key is transmitted from the consumer computing device to the merchant POS terminal to indicate completion of the ECOM POS transaction.

In one or more embodiments, the consumer and/or merchant associate may also or alternatively enter into the merchant POS terminal an alphanumeric code provided by the merchant digital storefront to the consumer computing device in connection with completion of the transaction to confirm such completion.

Referring to operation 526, the merchant POS terminal, operating according to the ECOM POS flow, may, upon receipt of the confirmation of transaction completion, request consumer identification. In one or more embodiments, the merchant POS terminal first analyzes the product(s) purchased and matches same against a listing of controlled items requiring a check of consumer identification and, wherever a match occurs, the consumer identification check is requested. The merchant POS terminal may also and/or simultaneously inform the merchant associate of the type of identification and parameters for satisfaction of the check associated with the product(s), according to the listing.

Referring to operation 528, the consumer may provide the requested identification to the merchant. In one or more embodiments, the identification is in the form of a government-issued license or other identification. The identification may be scanned by the merchant POS terminal and/or visually checked by the merchant associate for satisfaction of the one or more parameters for purchasing the controlled product(s).

Referring to operation 530, confirmation of the valid identification check may be entered at the merchant POS terminal. The merchant POS terminal may automatically determine satisfaction and/or the merchant associate may manually determine satisfaction and provide user input to the merchant POS terminal indicating same. The merchant POS terminal may make a record of such a check and satisfaction of the corresponding requirements.

Referring to operation 532, the merchant POS terminal may indicate completion of the ECOM POS transaction flow. In one or more embodiments, the merchant POS terminal and/or merchant associate confirms completion of the transaction (e.g., via receipt of the merchant private key or other confirmation) and of any optional identification checks, and permits the consumer to leave the merchant physical location with the purchased product(s) based thereon.

In one or more embodiments, the merchant POS terminal and/or merchant digital storefront may keep a record of the transaction data and merchant private key which can be used for resolving chargebacks and for conducting fraud review(s).

Further, in one or more embodiments, the merchant POS terminal may print a receipt, store an action item to send a digital receipt to the consumer via email upon resolution of the disruptoin, and/or may digitally transmit a receipt to the consumer computing device (e.g., via NFC or optical QR code) in connection with the transaction.

Referring to operation 534, inventory records for the merchant may be updated once the communication and/or connectivity disruption at the merchant POS terminal is resolved. For example, in one or more embodiments, the stored record of the transaction may be consulted and/or the merchant digital storefront may communicate with the merchant physical location or corresponding online records relating thereto to reflect transfer of the purchased product(s) to the consumer and corresponding reduction in inventory for the merchant physical location.

The merchant POS terminal or other onsite merchant computing device may automatically perform such inventory updates based on automatic identification of resolution of the disruption and/or return of normal or adequate communication and/or connectivity for the merchant POS terminal. For example, the merchant POS terminal may implement the scanning and/or monitoring procedure(s) discussed above, and/or merchant associate manual input, in connection with identifying the existence of the disruption to instead identify resolution of the disruption.

Advantageously, the systems and methods of the disclosure detailed above enable a merchant to reduce the risk of fraudulent or unsuccessful transactions while continuing to make point-of-sale terminal-initiated financial transactions during communication interruptions.

A reconfigured merchant point-of-sale terminal and merchant server may cooperate with a complementarily-configured cardholder payment application under embodiments of the present invention to provide a technical solution to the problem. More particularly, the reconfigured merchant point-of-sale terminal and merchant server complete a new transaction type responsive to network or communication interruptions—referred to herein as an ecommerce point-of-sale transaction (ECOM POS). The ECOM POS transaction type may bypass the interrupted or disrupted communication lines typically implemented for merchant point-of-sale terminal-initiated financial transactions while avoiding many of the risks inherent in offline transactions.

As will be appreciated, based upon the description herein, the technical improvement in enabling a merchant and cardholder to transact in this manner is a computer-based solution to a technical deficiency or problem that is itself rooted in computer technology (i.e., the problem itself derives from the use of computer technology). The present disclosure improves upon the conventional methods and systems in the manners described herein.

### ADDITIONAL CONSIDERATIONS

In this description, references to “one or more embodiments,” “an embodiment,” or “embodiments” mean that the feature or features being referred to are included in at least one or more embodiments of the technology. Separate references to “one or more embodiments,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one or more embodiments may also be included in other embodiments but is not necessarily included. Thus, the current technology can include a variety of combinations and/or integrations of the embodiments described herein.

The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the invention.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

As used herein, the phrases “payment card,” “payment device,” “transaction card,” “financial transaction card,” and the like refer to any suitable cashless payment device, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, transponder devices, NFC-enabled devices, and/or computers. Each type of payment card can be used as a method of payment for performing a transaction.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor comprises a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

1. Non-transitory computer-readable storage media having computer-executable instructions stored thereon for bypassing communication network disruptions in point-of-sale terminal-initiated financial transactions, wherein when executed by at least one processor the computer-executable instructions cause the at least one processor to:
receive, at a consumer mobile device having a payment application, user input initiating a payment transaction;
based on the user input, prompt a merchant point-of-sale terminal via the payment application for transaction data for the payment transaction, the transaction data identifying a product for purchase and an amount;
receive, at the consumer mobile device and from the merchant point-of-sale terminal, the transaction data;
transmit the transaction data from the consumer mobile device to a merchant server;
receive, from the merchant server and at the consumer mobile device, a prompt to complete a transaction corresponding to the transaction data;
receive acceptance input from the consumer at the consumer mobile device;
based on the acceptance input, transmit an acceptance to complete the transaction; and
transmit, via the payment application, a confirmation of transaction completion to the merchant point-of-sale terminal, the confirmation of transaction completion being encoded with a merchant private key for storage by the merchant point-of-sale terminal.

2. The non-transitory computer-readable media of claim 1, wherein the transaction data transmitted to the merchant server includes a merchant location identifier for use in computing a tax applicable to the transaction and used to complete the transaction.

3. The non-transitory computer-readable media of claim 2, wherein the merchant location identifier is received from the point-of-sale terminal.

4. The non-transitory computer-readable media of claim 2, wherein the merchant location identifier is determined by the consumer mobile device via one or more of the following: a location service accessible to the consumer mobile device; ping data that includes geotemporal data, from cell location register information held by a telecommunications provider to which the consumer mobile device is connected; and IP address register information.

5. The non-transitory computer-readable media of claim 1, wherein the acceptance is transmitted to the merchant server to complete the transaction, the merchant server coding the transaction as an ecommerce point-of-sale transaction.

6. (canceled)

7. The non-transitory computer-readable media of claim 1, wherein the payment application receives the transaction data from the point-of-sale terminal via at least one of Near Field Communication (NFC) transmission and displayed quick response (QR) optical code.

8-9. (canceled)

10. The non-transitory computer-readable media of claim 1, wherein, when executed by the at least one processor, the computer-executable instructions cause the at least one processor to receive a digital receipt for the completed transaction from the point-of-sale terminal.

11. Non-transitory computer-readable storage media having computer-executable instructions stored thereon for bypassing communication network disruptions in point-of-sale terminal-initiated financial transactions, wherein when executed by at least one processor the computer-executable instructions cause the at least one processor to:
transmit, from a merchant point-of-sale terminal, transaction data for a payment transaction to a consumer mobile device, the transaction data identifying a product for purchase and an amount;
receive, from the consumer mobile device, the transaction data at a merchant server;
determine, at the merchant server, that the transaction data corresponds to a transaction initiated at a merchant location;
based on the determination, automatically prepare, at the merchant server, a prompt to complete a transaction corresponding to the transaction data;
transmit the prompt to the consumer mobile device;
receive, at the merchant point-of-sale terminal and from the consumer mobile device, a transmission indicating acceptance by the consumer of the transaction;
automatically identify resolution of a state of communication network disruption following receipt of the transmission indicating acceptance by the consumer of the transaction; and
based on the identification of resolution, automatically update an inventory record to reflect completion of the transaction.

12. The non-transitory computer-readable media of claim 11, wherein the computer-executable instructions, when executed by the at least one processor, cause the at least one processor to:
receive, at the merchant server, a merchant location identifier from the consumer mobile device,
compute, at the merchant server and based on the merchant location identifier, a tax for inclusion in the prompt to complete the transaction.

13. The non-transitory computer-readable media of claim 11, wherein the computer-executable instructions, when executed by the at least one processor, cause the at least one processor to code the transaction as an ecommerce point-of-sale transaction at the merchant server.

14. The non-transitory computer-readable media of claim 11, wherein the computer-executable instructions, when executed by the at least one processor, cause the point-of-sale terminal to transmit the transaction data to the consumer mobile device in response to a transmission from the consumer mobile device initiating the transaction.

15. The non-transitory computer-readable media of claim 14, wherein the computer-executable instructions, when executed by the at least one processor, cause the point-of-sale terminal to identify the state of communication network disruption, the transmission of the transaction data to the consumer mobile device being based at least in part on the identification of the state of communication network disruption.

16. The non-transitory computer-readable media of claim 11, wherein the transmission of the transaction data to the consumer mobile device is via at least one of Near Field Communication (NFC) transmission and displayed quick response (QR) optical code.

17. The non-transitory computer-readable media of claim 11, wherein, when executed by the at least one processor, the computer-executable instructions cause the at least one processor to receive, at the point-of-sale terminal, a confirmation of consumer identification.

18. The non-transitory computer-readable media of claim 11, wherein the transmission indicating acceptance by the consumer of the transaction is encoded with a merchant private key.

19. The non-transitory computer-readable media of claim 11, wherein the transaction data transmitted from the point-of-sale terminal to the consumer mobile device includes a merchant processing website link to the merchant server.

20. (canceled)
